(19) United States
(12) Patent Application Publication
(10) Pub. No.: US 2021/0034506 A1
(43) Pub. Date: Feb. 4, 2021

(54) TESTING A COMPUTER PROGRAM

(71) Applicant: Hewlett Packard Enterprise Development LP, Houston, TX (US)

(72) Inventors: Pavan Sridhar, Bangalore Karnataka (IN); Deepak Panambur, Bangalore Karnataka (IN); Rohith Panambur, Bangalore Karnataka (IN)

(21) Appl. No.: 16/527,233

(22) Filed: Jul. 31, 2019

(51) Int. Cl. G06F 11/36

(52) U.S. Cl. CPC G06F 11/3688; G06F 11/3692; G06F 11/3684

(57) ABSTRACT

Examples described relate to examples for testing a computer program. In an example, a first set of factors to be considered in a first test plan for testing a computer program may be selected. A first set of test data may be assigned to the first set of factors. A first test may be performed on the computer program, based on the first set of factors, considering the first set of test data. The first test results obtained in response to performing the first test on the computer program may be analyzed. In response to analyzing the first test results, at least one of the first test plan, the first set of factors, and the first set of test data for testing the computer program may be updated.

### BACKGROUND

DevOps (development and operations) may refer to a software development phrase or practice that emphasizes collaboration and communication between development and IT production teams. It aims at establishing a culture and environment where building, testing, and releasing software may happen rapidly, frequently, and more reliably. DevOps advocates synchronization between development teams and IT teams from the first phase of software development till the software is deployed.

### BRIEF DESCRIPTION OF THE DRAWINGS

For a better understanding of the solution, examples will now be described, with reference to the accompanying drawings, in which:

FIG. 1 is a block diagram of an example computing system for testing a computer program;

FIG. 2 is table illustrating example factors for testing a computer program;

FIG. 3 is a block diagram of an example computing system for testing a computer program;

FIG. 4 is a flowchart of an example method of testing a computer program; and

FIG. 5 is a block diagram of an example system including instructions in a machine-readable storage medium for testing a computer program.

### DETAILED DESCRIPTION

In recent years, unification of development and operations teams (called DevOps) for development of software has been advocated. DevOps encourages removal of barriers between development (Dev) and operations (Ops) team to speed up the release of software.

In a typical DevOps environment, an application may first be built using a build system. The build artifacts may be packaged and delivered to various groups in an organization for deploying and testing. These packages may follow a pipeline. For example, the package may first be placed in a development environment by developers, then in a testing environment by a Quality Assurance (QA) team, later in a staging environment by an IT release team, and so on so forth. Thus, an application may be placed and tested in various environments before it is released. During the process, an application may pass through a rigorous process during which various tests may be executed in different environments. This process may be repeated every time for all new builds or packages.

Software testing remains one of the areas which may get squeezed to meet deadlines due to delay in various stages of the Software Development Life Cycle (SDLC). This invariably means testing may involve racing against time and taking risks that are logical in manner based on an assessment of various risk factors. However, optimal risk calculation needed for planning and execution of tests is a challenging task. Selection of irrelevant factors in a software testing method may lead to inappropriate outputs, which could result in costly failures in future efforts.

Artificial Intelligence—Machine Learning (AI/ML) in software testing as part of SDLC traditionally relies on historical data to provide futuristic insights. However, a testing method ideally should not rely on historical test data, since the data may become irrelevant due to a variety of factors. When the data becomes irrelevant, optimal risk calculation for planning and execution of software tests using AI/ML becomes a challenging task. Due to lack of relevant information, an AI/ML-based testing model's output may become inappropriate, and this may adversely impact future testing efforts.

To address these technical challenges, the present disclosure describes various examples for testing a computer program. In an example, a first set of factors to be considered in a first test plan for testing a computer program may be selected. A first set of test data may be assigned to the first set of factors. A first test may be performed on the computer program, based on the first set of factors, considering the first set of test data. The first test results obtained in response to performing the first test on the computer program may be analyzed. In response to analyzing the first test results, at least one of the first test plan, the first set of factors, and the first set of test data for testing the computer program may be updated. The proposed AI/ML-based software testing solution may not only factor in a lack of historical test data to begin with but may also take into account a scenario wherein the test data may become irrelevant due to va

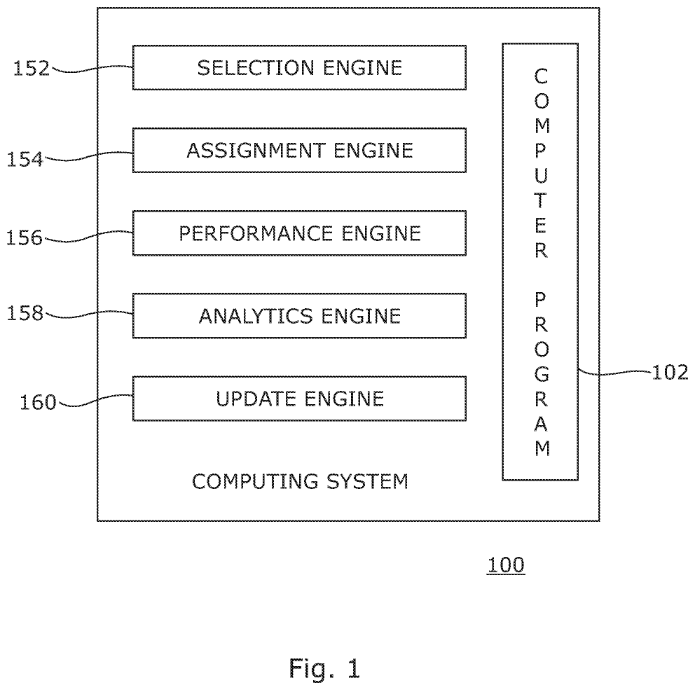

FIG. 1 is a block diagram of an example computing system 100 for testing a computer program.

In an example, computing system 100 may represent any type of computing device capable of reading machine-executable instructions. Examples of computing device may include, without limitation, a server, a desktop computer, a notebook computer, a tablet computer, a thin client, a mobile device, a personal digital assistant (PDA), and the like.

In an example, computing system 100 may include a computer program 102. The computer program 102 may be present on a storage device. The storage device may be an internal storage device, an external storage device, or a network attached storage device. Examples of the storage device may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In other examples, the storage device may be a Direct Attached Storage (DAS) device, a Network Attached Storage (NAS) device, a Redundant Array of Inexpensive Disks (RAID), a data archival storage system, or a block-based device over a storage area network (SAN). In one example, the storage device may be a storage array, which may include one or more storage drives (for example, hard disk drives, solid state drives, etc.).

The computer program 102 may include, for example, application software (e.g., a computer application), firmware, or system software (e.g., operating system, utility software, etc.).

In an example, computing system 100 may include a selection engine 152, an assignment engine 154, a performance engine 156, an analytics engine 158, and an update engine 160.

Engines 152, 154, 156, 158, and 160 (described below) may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of computing system 100. In some examples, the at least one machine-readable storage medium may store instructions that, when executed by the at least one processing resource, at least partially implement some or all engines of computing system 100. In such examples, computing system 100 may include the at least one machine-readable storage medium storing the instructions and the at least one processing resource to execute the instructions.

In an example, selection engine 152 may select a first set of factors to be considered in a first test plan for testing a computer program 102 (machine-executable instructions).

A test plan may include a document describing the scope, approach, resources and schedule of test activities intended for a computer program. Amongst other items, it may identify test items, the features to be tested, the testing tasks, who will do each task, the test environment, the test design techniques, etc. It may serve as a record of the test planning process.

A test plan may include one or more test cases. A test case may refer to a specification of the inputs, execution conditions, testing procedure, and expected results that define a single test to be executed to achieve a particular software testing objective. A test case may include a test step a sequence of test steps, to test a functionality or feature of a computer program (e.g., 102).

Some non-limiting examples of first test factors that may be considered in the first test plan for testing a computer program (e.g. 102) may include: the relevance of a test case in the test plan, the frequency of a test case in the test plan (i.e. how often the test case is run?), the defect rate of a test case in the test plan (i.e. how many defects the test case may yield?), the priority of a test case in the test plan, the duration of a test case in the test plan (i.e. test case run duration), the affinity of a test case in the test plan (i.e. dependency of the test case to a particular configuration), etc. In an example, the first set of factors may be user-defined and/or selected by a user. A user-interface may be provided for a user to input the first set of factors (or other factors).

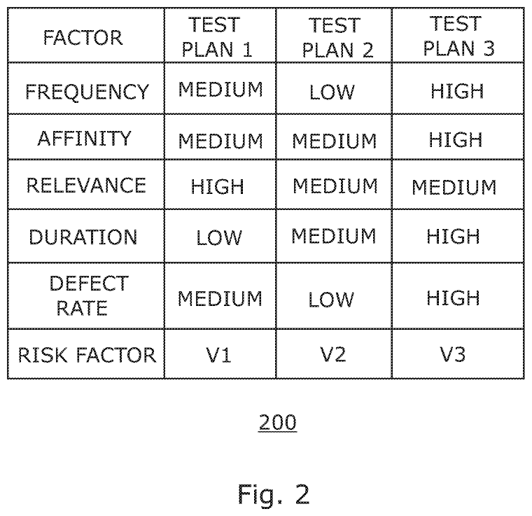

Assignment engine 154 may assign a first set of test data to the first set of factors. In an example, each factor in the first set of factors may be assigned a value (i.e. first set of test data). In an example, each value may be defined on a scale (for example, a nominal scale, an ordinal scale, an interval scale, etc.). For example, a value may be assigned to each factor in the first set of factors on a numerical scale (e.g., 1 to 100). In another example, a value may be assigned to each factor in the first set of factors on an ordinal scale (e.g., Low—Medium—High). This is illustrated in FIG. 2. FIG. 2 illustrates a table 200 that includes example factors such as Frequency, Affinity, Relevance, Priority, Duration, and Defect rate. In an example, these factors may be considered the first set of factors. Table 200 also shows example values defined for these factors on an ordinal scale (e.g., Low—Medium—High) for three test plans “Test plan 1”, “Test plan 2”, and “Test plan 3”.

Performance engine 156 may perform a first test on the computer program 102 based on the first set of factors, considering the first set of test data. Consequent to performing the first test, first test results may be obtained. Analytics engine 158 may analyze the first test results that are obtained in response to performing the first test on the computer program 102. In an example, analyzing of the first test results may comprise determining a second set of factors for testing the computer program 102. In another example, analyzing may comprise determining a second set of test data for the first set of factors. In a further example, analyzing may comprise identifying test cases to be included in the first test plan for testing the computer program 102. In a yet another example, analyzing may comprise identifying test cases to be removed from the first test plan for testing the computer program 102. In a further example, analyzing may comprise identifying an additional factor for inclusion in the first set of factors. In a still further example, analyzing may comprise identifying a factor for removal from the first set of factors.

In an example, analyzing may involve determining a risk factor for performing the first test on the computer program 102. In an example, the risk factor may be calculated based on a function between the first set of factors and the first set of test data. Some non-limiting examples of the function that may be used may include a mathematical function, a statistical method (e.g., simple aggregate method or weighted method), and/or a machine learning method. Based on the method used, a risk factor for performing the first test on the computer program 102, considering the first set of factors and the first set of test data, may be determined. This is illustrated in FIG. 2. Table 200 also shows example values defined for these factors on an ordinal scale (e.g., Low—Medium—High) for three test plans “Test plan 1”, “Test plan 2”, and “Test plan 3”. Table 200 shows example risk factors “V1”, “V2”, and “V3” that may be determined based on a function between the first set of factors (i.e. Frequency, Affinity, Relevance, Priority, Duration, and Defect rate) and the first set of test data (as illustrated in FIG. 2) for three test plans “Test plan 1”, “Test plan 2”, and “Test plan 3”.

In an example, a threshold value may be defined for the risk factor. Depending on the threshold value, an action(s) may be performed by analytics engine. For example, if the risk factor is below a pre-defined threshold, analytics engine 158 may identify test cases that may be removed from the first test plan for testing the computer program 102. In another example, if the risk factor is above a pre-defined threshold, analytics engine 158 may identify test cases that may be included in the first test plan for testing the computer program 102.

In response to analyzing the first test results, update engine 160 may update, for example, the first test plan, the first set of factors and/or the first set of test data for testing the computer program 102.

In some examples, updating the first test plan for testing the computer program 102 may comprise: updating a test case in the first test plan; updating a test step included in a test case in the first test plan; selecting a second set of factors in the first test plan; selecting a new test plan for testing the computer program 102; removing a test case from the first test plan for testing the computer program 102; including a test case in the first test plan for testing the computer program 102; removing a test step from a test case in the first test plan for testing the computer program 102; and/or including a test step from a test case in the first test plan for testing the computer program 102.

In some examples, updating the first set of factors may comprise: assigning a second set of test data to the first set of factors; including an additional factor in the first set of factors; and/or removing a factor from the first set of factors.

In some examples, updating the first set of test data may comprise: replacing the first set of test data with a second set of test data; including new test data in the first set of test data; and/or removing existing test data from the first set of test data.

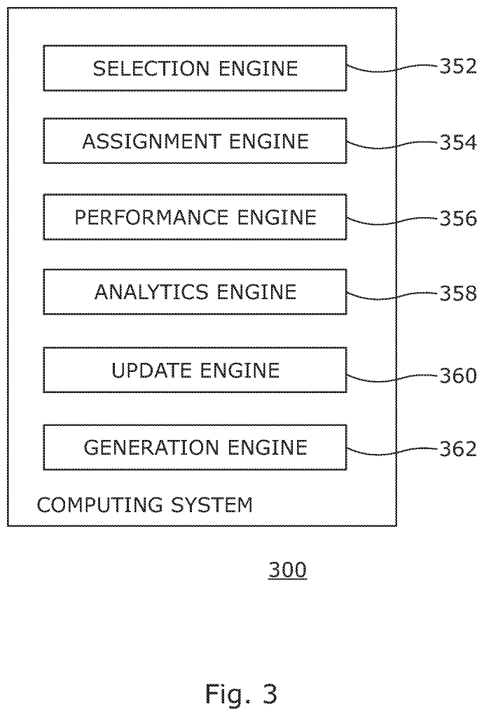

FIG. 3 is a block diagram of an example computing system 300 for testing a computer program 102. In an example, computing system 300 may be analogous to the computing system 100 of FIG. 1, in which like reference numerals correspond to the same or similar, though perhaps not identical, components. For the sake of brevity, components or reference numerals of FIG. 3 having a same or similarly described function in FIG. 1 are not being described in detail in connection with FIG. 3. Said components or reference numerals may be considered alike.

In an example, computing system 300 may include a selection engine 352, an assignment engine 354, a performance engine 356, an analytics engine 358, an update engine 360, and a generation engine 362. In an example, selection engine 352, assignment engine 353, performance engine 356, analytics engine 358, and update engine 360 may perform functionalities similar to those described earlier in reference to selection engine 152, assignment engine 154, performance engine 156, analytics engine 158, and update engine 160 of FIG. 1, respectively.

In an example, selection engine 352 may select a first set of factors to be considered in a first test plan for testing a computer program (e.g., 102). Assignment engine 354 may assign a first set of test data to the first set of factors. Performance engine 356 may perform a first test on the computer program based on the first set of factors, considering the first set of test data. Analytics engine 358 may analyze first test results obtained in response to performing the first test on the computer program. Update engine 360 may, in response to analyzing the first test results, update at least one of the first test plan, the first set of factors and the first set of test data for testing the computer program.

In an example, in response to updating at least one of the first test plan, the first set of factors, and the first set of test data, generation engine 362 may generate at least one of a second test plan, a second set of factors, and a second set of test data. Performance engine 356 may then perform a second test on the computer program based on at least one of the second test plan, the second set of factors, and the second set of test data. Analytics engine 354 may analyze second test results obtained in response to performing the second test on the computer program. In response to analyzing the second test results, update engine 360 may update at least one of the second test plan, the second set of factors, and the second set of test data for testing the computer program.

Likewise, in response to updating at least one of the second test plan, the second set of factors, and the second set of test data, generation engine 362 may generate at least one of an nth test plan, an nth set of factors, and an nth set of test data. Performance engine 356 may perform an nth test on the computer program based on at least one of the nth test plan, the nth set of factors, and the nth set of test data. Analytics engine 358 may analyze nth test results obtained in response to performing the nth test on the computer program. In response to analyzing the nth test results, update engine 360 may at least one of the nth test plan, the nth set of factors, and the nth set of test data for testing the computer program.

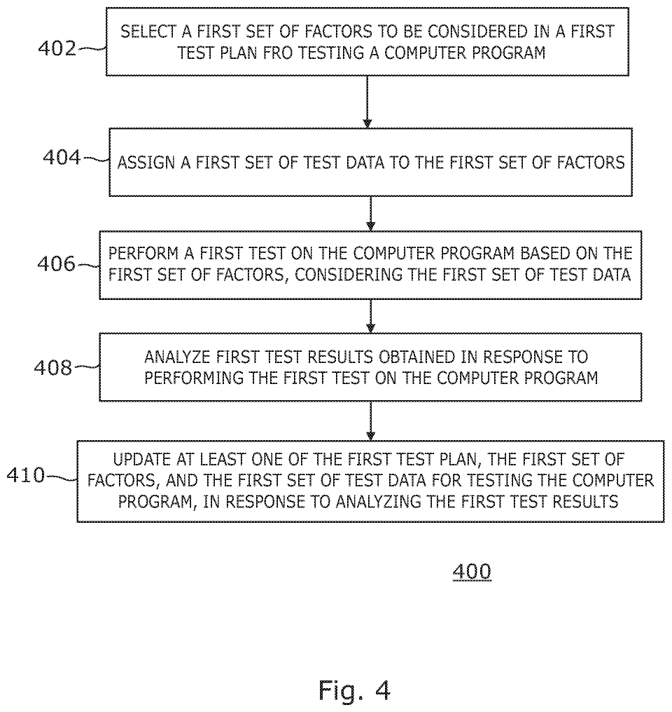

FIG. 4 is a flowchart of an example method 400 of testing a computer program. The method 400, which is described below, may be executed on a computing system such as computing system 100 of FIG. 1 or computing system 300 of FIG. 3. However, other computing platforms or computing devices may be used as well. At block 402, a first set of factors to be considered in a first test plan for testing a computer program may be selected. At block 404, a first set of test data may be assigned to the first set of factors. At block 406, a first test may be performed on the computer program, based on the first set of factors, considering the first set of test data. At block 408, first test results obtained in response to performing the first test on the computer program may be analyzed. At block 410, in response to analyzing the first test results, at least one of the first test plan, the first set of factors, and the first set of test data for testing the computer program may be updated.

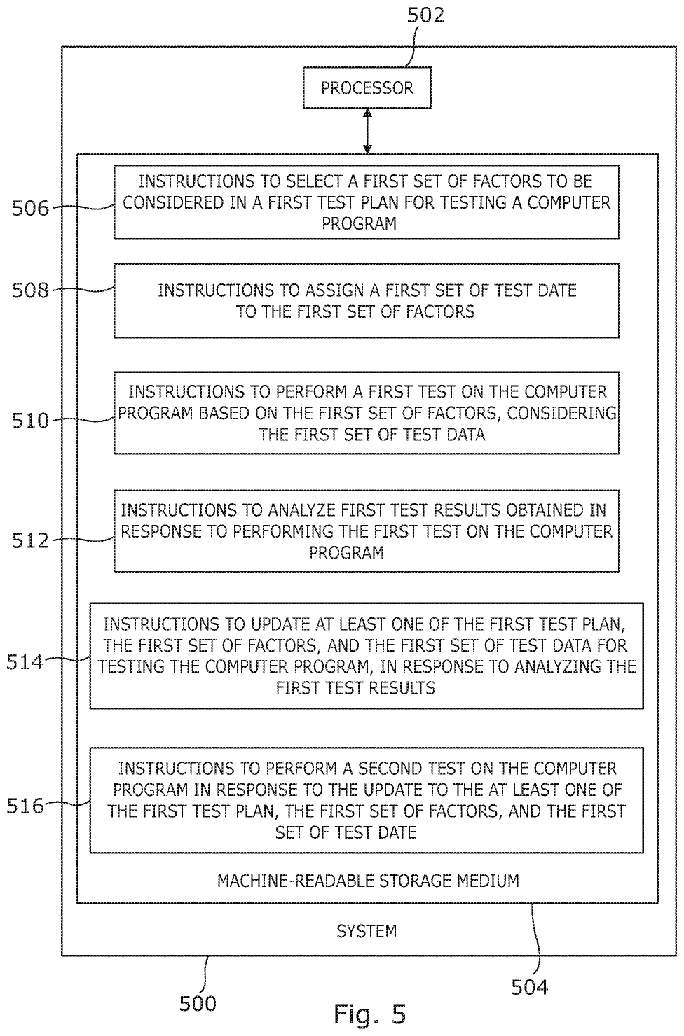

FIG. 5 is a block diagram of an example system 500 including instructions in a machine-readable storage medium for testing a computer program. System 500 includes a processor 502 and a machine-readable storage medium 504 communicatively coupled through a system bus. In some examples, system 500 may be analogous to computing system 100 of FIG. 1 or computing system 300 of FIG. 3. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 504 may store instructions 506, 508, 510, 512, 515, and 516.

In an example, instructions 506 may be executed by processor 502 to select a first set of factors to be considered in a first test plan for testing a computer program. Instructions 508 may be executed by processor 502 to assign a first set of test data to the first set of factors. Instructions 510 may be executed by processor 502 to perform a first test on the computer program based on the first set of factors, considering the first set of test data. Instructions 512 may be executed by processor 502 to analyze first test results obtained in response to performing the first test on the computer program. Instructions 514 may be executed by processor 502 to update at least one of the first test plan, the first set of factors and the first set of test data for testing the computer program, in response to analyzing the first test results. Instructions 516 may be executed by processor 502 to perform a second test on the computer program in response to the update to the at least one of the first test plan, the first set of factors, and the first set of test data.

For the purpose of simplicity of explanation, the example method of FIG. 4 is shown as executing serially, however it is to be understood and appreciated that the present and other examples are not limited by the illustrated order. The example systems of FIGS. 1, 3, and 5, and method of FIG. 4 may be implemented in the form of a computer program product including computer-executable instructions, such as program code, which may be run on any suitable computing device in conjunction with a suitable operating system (for example, Microsoft Windows®, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution.

1. A method, comprising:
selecting a first set of factors to be considered in a first test plan for testing a computer program;
assigning a first set of test data to the first set of factors;
performing a first test on the computer program based on the first set of factors, considering the first set of test data;
analyzing first test results obtained in response to performing the first test on the computer program; and
in response to analyzing the first test results, updating at least one of the first test plan, the first set of factors, and the first set of test data for testing the computer program.

2. The method of claim 1, further comprising:
in response to updating, generating at least one of a second test plan, a second set of factors, and a second set of test data;
performing a second test on the computer program based on at least one of the second test plan, the second set of factors, and the second set of test data;
analyzing second test results obtained in response to performing the second test on the computer program; and
in response to analyzing the second test results, updating at least one of the second test plan, the second set of factors, and the second set of test data for testing the computer program.

3. The method of claim 2, further comprising:
in response to updating, generating at least one of an nth test plan, an nth set of factors, and an nth set of test data;
performing an nth test on the computer program based on at least one of the nth test plan, the nth set of factors, and the nth set of test data;
analyzing nth test results obtained in response to performing the nth test on the computer program; and
in response to analyzing the nth test results, updating at least one of the nth test plan, the nth set of factors, and the nth set of test data for testing the computer program.

4. The method of claim 1, wherein analyzing comprises determining a second set of factors for testing the computer program.

5. The method of claim 1, further comprising performing a second test on the computer program in response to updating the at least one of the first test plan, the first set of factors, and the first set of test data.

6. The method of claim 1, wherein analyzing comprises identifying test cases to be included in the first test plan for testing the computer program.

7. The method of claim 1, wherein updating the first test plan for testing the computer program comprises updating a test case in the first test plan.

8. The method of claim 1, wherein updating the first test plan for testing the computer program comprises updating a test step in a test case in the first test plan.

9. The method of claim 1, wherein analyzing comprises determining a risk factor for performing the first test on the computer program, wherein the risk factor is calculated based on a function used between the first set of factors and the first set of test data.

10. The method of claim 9, wherein the risk factor is used to determine an action related to at least one of the first test plan, the first set of factors, and the first set of test data.

11. The method of claim 1, wherein analyzing comprises identifying test cases to be removed from the first test plan for testing the computer program.

12. The method of claim 1, wherein analyzing comprises identifying an additional factor for inclusion in the first set of factors.

13. The method of claim 1, wherein analyzing comprises identifying a factor for removal from the first set of factors.

14. A system, comprising:
a selection engine to select a first set of factors to be considered in a first test plan for testing a computer program;
an assignment engine to assign a first set of test data to the first set of factors;
a performance engine to perform a first test on the computer program based on the first set of factors, considering the first set of test data;
an analytics engine to analyze first test results obtained in response to performing the first test on the computer program; and
an update engine to, in response to analyzing the first test results, update at least one of the first test plan, the first set of factors and the first set of test data for testing the computer program.

15. The system of claim 14, wherein the first test plan includes a test case for testing the computer program.

16. The system of claim 14, wherein the first test plan includes a test step for testing the computer program.

17. A non-transitory machine-readable storage medium comprising instructions, the instructions executable by a processor to:
select a first set of factors to be considered in a first test plan for testing a computer program;
assign a first set of test data to the first set of factors;
perform a first test on the computer program based on the first set of factors, considering the first set of test data;
analyze first test results obtained in response to performing the first test on the computer program;
update at least one of the first test plan, the first set of factors and the first set of test data for testing the computer program, in response to analyzing the first test results; and
perform a second test on the computer program in response to the update to the at least one of the first test plan, the first set of factors, and the first set of test data.

18. The storage medium of claim 17, wherein the instructions to update include instructions to select a second set of factors in the first test plan.

19. The storage medium of claim 17, wherein the instructions to update include instructions to select a new test plan for testing the computer program.

20. The storage medium of claim 17, wherein the instructions to update include instructions to assign a second set of test data to the first set of factors.
